(19) United States
(12) Patent Application Publication
(10) Pub. No.: US 2006/0028689 A1
(43) Pub. Date: Feb. 9, 2006

(54) Document management with embedded data

(76) Inventors: Burt W. Perry, Lake Oswego, OR (US); Sean Calhoon, Lake Oswego, OR (US); Alastair M. Reed, Lake Oswego, OR (US); Kenneth L. Levy, Stevenson, WA (US); Tim Schoenheit, Lake Oswego, OR (US); Geoffrey B. Rhoads, West Linn, OR (US)

Correspondence Address: DIGIMARC CORPORATION, 9405 SW GEMINI DRIVE, BEAVERTON, OR, 97008, US

(21) Appl. No.: 10/639,598

(22) Filed: Aug. 11, 2003

Related U.S. Application Data
(63) Continuation-in-part of application No. 10/367,092, filed on Feb. 13, 2003.
Application No. 10/367,092 is a continuation-in-part of application No. 09/185,380, filed on Nov. 3, 1998, now Pat. No. 6,549,638.
(63) Continuation-in-part of application No. 09/465,418, filed on Dec. 16, 1999.
(63) Continuation-in-part of application No. 09/612,177, filed on Jul. 6, 2000, now Pat. No. 6,681,029.
Application No. 09/612,177 is a continuation of application No. 08/746,613, filed on Nov. 12, 1996, now Pat. No. 6,122,403.
(60) Provisional application No. 60/403,899, filed on Aug. 15, 2002.
(60) Provisional application No. 60/112,955, filed on Dec. 18, 1998.

(51) Int. Cl. H04N 1/40

(52) U.S. Cl. 358/3.28

(57) ABSTRACT

This disclosure details systems and methods for embedding and reading auxiliary code signals in documents, and for using the code signals to enable a variety of forensic tracking, monitoring and usage control functions.

### RELATED APPLICATION DATA

This application claims the benefit of U.S. Provisional Patent Application No. 60/403,899, filed Aug. 15, 2002.

This application is a continuation in part of U.S. patent application Ser. No. 10/367,092, filed Feb. 13, 2003, which is a continuation in part of U.S. patent application Ser. No. 09/185,380, filed Nov. 3, 1998 (now U.S. Pat. No. 6,549,638).

This application is also a continuation in part of U.S. patent application Ser. No. 09/465,418, filed Dec. 16, 1999, which claims the benefit of U.S. Provisional Patent Application No. 60/112,955, filed Dec. 18, 1998.

This application is also a continuation in part of U.S. patent application Ser. No. 09/612,177, filed Jul. 6, 2000, which is a continuation of U.S. patent application Ser. No. 08/746,613, filed Nov. 12, 1996 (now U.S. Pat. No. 6,122,403).

The above U.S. patent documents are hereby incorporated by reference.

### TECHNICAL FIELD

The invention relates to document management and specifically relates to the use of machine-readable embedded data in documents for forensic tracking, usage and reproduction control, authentication, and linking to related actions and/or data.

### BACKGROUND AND SUMMARY

For many organizations, there is a critical need for technologies that enable them to track and control the use of documents that flow through the organization in electronic and printed form. With the rapid expansion of digital document processing and communication over networks, many have attempted to develop innovations that enable organizations to manage, track and control the use of electronic documents. However, there is a need for technology that can bridge the gap between the electronic and physical world.

Digital watermarks have been developed that survive printing and scanning processes. As such, they provide a mechanism for embedding machine-readable auxiliary data in documents that can be used to track and control the use of the documents in both digital and physical form. The challenge with using digital watermarks to manage documents is to effectively integrate digital watermark embedders and readers in document creation and rendering systems used in corporate and government organizations.

Digital watermarking is a process for modifying physical or electronic media to embed a hidden machine-readable code into the media. For electronic media, such as an image signal, the image data is modified to embed the hidden code. For physical media, the surface texture or image is modified to embed the hidden code. For example, an electronic image is modified to embed the code, and then the modified image is printed on the physical object such that the printed object carries the code. The media may be modified such that the embedded code is imperceptible or nearly imperceptible to the user, yet may be detected through an automated detection process. Most commonly, digital watermarking is applied to media signals such as images (including print images, photographs, document images, digital images, etc.), audio signals, and video signals. However, it may also be applied to other types of media objects, including documents (e.g., through line, word or character shifting), software, multi-dimensional graphics models, and surface textures of objects.

Digital watermarking systems typically have two primary components: an encoder that embeds the watermark in a host media signal, and a decoder that detects and reads the embedded watermark from a signal suspected of containing a watermark (a suspect signal). The encoder embeds a watermark by subtly altering the host media signal. The reading component analyzes a suspect signal to detect whether a watermark is present. In applications where the watermark encodes information, the reader extracts this information from the detected watermark.

Several particular digital watermarking techniques have been developed. The reader is presumed to be familiar with the literature in this field. Particular techniques for embedding and detecting imperceptible watermarks in media signals are detailed in the assignee's U.S. patent application Ser. No. 09/503,881 (allowed) and U.S. Pat. No. 6,122,403, which are hereby incorporated by reference.

This disclosure details systems and methods for embedding and reading auxiliary code signals in documents, and for using the code signals to enable a variety of forensic tracking and usage control functions.

### BRIEF DESCRIPTION OF THE DRAWINGS

FIG. 1 is a system diagram illustrating locations of embedders for embedding auxiliary data, such as copy control and forensic tracking information, in documents.

FIG. 2 is a system diagram illustrating locations of readers for extracting the embedded data from printed documents.

### DETAILED DESCRIPTION

Overview

The following sections describe a document management system that uses machine-readable embedded code signals to add functionality to documents. This system is implemented in computing environments, such as networks within corporate or government organizations, that afford an opportunity to control embedding and reading of the code signals as the documents are created, printed, and/or reproduced. To facilitate this control, the system includes embedders that insert the embedded code signal into a document at the time of creation, including at the time of saving or printing an electronic file representing a document. The system also includes readers that extract the embedded code signal and take some action based on the embedded code signal and context information. One example of such an action is controlling the use, printing or reproduction of the document. For the purpose of this technical description, the term “document” encompasses a wide variety of document types created in computing environments, including word processing documents, spreadsheets, presentations, database reports, etc.

The readers may be incorporated within a software application used to edit or manage documents, within an operating system, within scanning device hardware (e.g., a copier or document scanner), and/or within a device driver. The placement of readers at these various locations enables the embedded code signal to initiate document control, management and tracking functions at various stages in the lifecycle of a document. For example, the reader can trigger actions at the time of file opening, file printing, file rasterizing, document scanning, document faxing or document copying.

The embedded code signal enables a variety of functions. These functions include copy prevention and control, such as inhibiting the printing, scanning, or reproduction of a document. In this case, the embedded code includes copy control instructions and/or document classification codes that specify the copy control functions to be taken by printing, scanning or reproduction device in response to reading the embedded code signal in a hardware or software reader associated with the printer, scanner or reproduction device. Since the embedded code is represented in both the electronic file and the printed version of the document, actions triggered by the code may be executed at the time the electronic file is opened as well as when the printed document is scanned.

Another function is forensic tracking, where the embedded code signal conveys a source identifier of a user and/or device that created the document. In this case, the reader may be a stand-alone system or hand held device used to extract the source identifier and trace the document to its source. This tracing operation may involve a look up operation where the source identifier indexes a database entry that stores source information, such as the name of a user, machine or class of users or machines that created the document. The user may enter the source identifier at the time the document is printed or reproduced. In response, an embedder encodes that source identifier into the document as it is printed or reproduced. For example, when the user enters a personal access code on the printer at the time of printing, the embedder inserts that personal access code into the code signal embedded into the document. In addition to a source identifier, the embedded code signal may also carry a unique document identifier.

Readers located within rendering or reproduction devices, such as copiers, may then be designed to keep a log of the time and place that documents are printed or reproduced based on detection of the embedded code signal in the document. This enables document printing and copying transactions to be recorded along with the time, and place in a transaction log. The time and place information from these transaction log records can then be matched with surveillance video that monitors personnel using the printing and/or copying machines at a particular time and place. In particular, if a facility requires users to enter access codes at the printer/copier, then the surveillance video will capture video of the person that printed the document that can be correlated with the transaction log generated by the embedded code readers.

Surveillance video may be more tightly linked to events in which the embedded code signal reader detects the code signal in a document at the time of printing or copying of a document with an embedded code signal. For example, the surveillance video system includes short-term memory buffers that continually buffer the last X seconds of video (e.g., 20 seconds). When the reader detects an embedded code signal indicating an unauthorized printing or copying activity, it sends a signal to the video surveillance system to store the buffered X seconds of video before the detection event, along with Y seconds of video after the event at a particular camera associated with the reader location. For more information on associating surveillance video with an embedded code signal detection event, see, e.g., co-pending U.S. Provisional Patent Application No. 60/367,033.

In some forensic tracking applications, the embedded code signal carries an auxiliary data payload including a source identifier specifying the document source (e.g., person or machine), a destination identifier that provides information about the intended or authorized recipients (e.g., a department, person, location, etc.), usage codes, and/or a unique document identifier. A unique document identifier can serve multiple functions by associating the unique document identifier with information about its intended destination. Readers in the document's processing and handling path within the system maintain an audit trail comprising a log of detection events of the embedded code signal. This log indicates who or what process or device handled the document, along with the document identifier and other context information such as the time and place of the detection. Readers can also enable or disable printing or copying (with or without a banner) based on the usage information in the embedded code signal, and/or the destination identifier. For example, printing and copying can be disabled at unauthorized destinations not corresponding to the embedded destination identifier. Finally, forensic identifiers can be used to analyze a leaked document and determine its source by extracting the source identifier.

Another function is linking the document to an action. In this case, the embedded code signal carries an identifier that is associated with an action and/or data. This function highlights the broad range of applications that can be enabled through the embedded code signal because the associated actions and data are numerous. One example is to use the identifier to index an entry in a database that specifies an action to be performed in response to reading the embedded code signal, such as fetching and displaying a web page, launching an application program, launching a document editor program that presents an electronic and editable version of the document, invoking a client program of an electronic document management system that provides information about the document, etc. Another example is to index a database entry that stores useful information about the document and displaying this useful information in response to reading the embedded code signal.

The embedded code signal may be used to link a document to an electronic document management system (EDMS) for document privileges or tracking. For example, upon detection of the code signal, the embedded code reader accesses the EDMS database and provides a document identifier extracted from the embedded code signal. The EDMS database then returns the privileges associated with that document identifier, such as security clearance information, rights management information, and rules about reproduction, printing with or without a banner, etc. For tracking the document, the reader supplies information about the time, date, person, location, etc. involved in printing or reproducing the document, and in response, the EDMS database records this information in a transaction event associated with the document identifier.

Another function is tagging the document with a stamp in response to reading the embedded code signal. In this case, the embedded code signal triggers a process for applying a tag to the document.

In all of the above cases, the response to reading of the embedded code may be a function of the embedded code itself, and some context information, such as the time and location of the detection, a user identifier (e.g., a pass code entered by the user), transaction history of the document (e.g., how many transaction events have been logged on the document); the history of the user (e.g., what has the user done with the document or like documents before), the security or confidential status of the user, machine or location, etc. The response may be based on the embedded code only, the embedded code and local context information, the embedded code and information indexed by the embedded code in a local or remote table or database entry, or some combination of this information.

Assignee's previous patent filings include additional information on systems and methods for embedding and reading code signals in documents. These include:

Methods for embedding a digital watermark in a PDL file, such as PDF or PostScript. See, for example, U.S. patent application Ser. No. 10/066,116 (published as U.S. 2003-0142361 A1), and Ser. No. 09/810,000—including watermark embedding control commands in a PDL file—(published as U.S. 2001-0054150 A1).

Methods for linking a printed document to additional data and actions. See, for example, U.S. patent application Ser. No. 09/629,401 (now U.S. Pat. No. 6,522,770), Ser. Nos. 09/571,422 and 09/343,104.

Methods for digital watermark encoding and decoding in peripheral device drivers. See, for example, U.S. patent application Ser. No. 09/659,125. See also, U.S. patent application Ser. No. 09/515,826, which describes inserting the watermark with a printer driver and keeping the watermark separate from the image or text in the document until the document is printed.

Methods for digital watermarking of fonts. See, for example, U.S. patent application Ser. No. 10/187,252.

Methods for embedding codes in documents using background tinting. See, for example, U.S. Pat. No. 6,345,104, and U.S. patent application Ser. Nos. 09/465,418 and 09/571,422.

Methods for using embedded code signals in documents for copy control and forensic tracking. See, for example, U.S. Provisional Patent Application No. 60/112,955, U.S. patent application Ser. No. 09/185,380 (now U.S. Pat. No. 6,549,638), and International Application PCT/US99/08252 (published as WO99/53428).

Methods for using watermark embedders and readers in software and devices, including distributed spiders used in networks for monitoring and logging of watermarked content, and for filtering watermarked files and email. See, e.g., PCT/US01/04812 (published as WO 01/61508).

Methods for authenticating printed objects. See, for example, U.S. patent application Ser. No. 09/938,870 (published as U.S. 2002-0099943 A1).

Methods for using digital watermarks in documents as a communication channel for controlling document processing devices, such as printers, scanners, copiers and fax machines. See, for example, International Application PCT/US02/11445 (published as WO 02/087129).

Methods for associating surveillance video along with digital watermark detection events. See, for example, U.S. Provisional Patent Application No. 60/367,033.

Methods for using an embedded code signal to prevent access, control editing rights, control transmission rights, and maintain an audit trail. See, for example, International Application PCT/US02/06858 (published as WO 02/071685).

For more information on using digital watermarks in printed media see, e.g., U.S. patent application Ser. No. 09/811,366 (published as U.S. 2002-0018579 A1).

The above U.S. Patent Documents are hereby incorporated by reference.

Embedded Signal

In one implementation, the embedded code signal has the following properties:

1. It is combined with an image representation of the document to form a rasterized document with an embedded code signal;

2. The data carried in the embedded code signal is machine readable from a printed version of the document, and as such, survives printing and scanning processes; and

3. The data carried in the embedded code signal is hidden such that a viewer of the printed document cannot interpret it or recognize its existence, although embedded code signal may introduce visible modifications to the document (e.g., such as a subtle background tint or texture pattern). The modification introduced by the code signal on the rendered version of the document do not change the semantic meaning of the information on the document to a human viewer, such as the text characters, line art, graphics or pictures. For example, a text document may appear different to the viewer, but the viewer can still recognize the characters, lines, etc. such that the meaning and value of the document is not diminished.

With respect to item 1 above, the embedded code signal may be inserted in an editable document, such as an editable PDL document in a manner that keeps the embedded code signal separate from the rest of the contents of the document until the entire document is rasterized. In this case, the semantic information in the document, such as text information represented as ASCII or compressed ASCII text remains available for editing by users. Later, when the document is rasterized for printing, the embedded code signal is combined with the rasterized semantic content (e.g., text, graphics, line art, etc.). One example is an embedded code signal in the form of a background tint image. The background tint may be specified in the PDL in the document file without altering the other contents of the file. Then, at the time of rasterizing, the rasterized pages of the document are superimposed onto the background tint image to form a composite image for each page. Alternatively, the embedded code signal may be used to alter the halftone representation of the semantic information at the time of rasterizing. This approach maintains the original semantic information in the document in an editable and compact form until rasterizing (e.g., rasterizing as part of a printing operation). Even after printing, the PDL file may remain in editable form with the embedded code signal inserted in the file.

In our implementation, the embedder generates the embedded code signal so that it includes a digital message payload, comprising a sequence of message symbols. In our case, these symbols are binary, but they need not be. This embedded code signal includes calibration signal attributes that enable the reader to detect the embedded code signal and compensate for geometric distortion, including rotation and scaling.

In one particular implementation, the process of generating the embedded code signal includes the following steps:

1. Form a digital message payload, including one or more separate message parts, with some parts having variable symbols, and some having fixed symbols.

2. Append error detection symbols used to validate accuracy of a decoded message in the reader. These symbols form part of the payload.

3. Apply a combination of error correction and repetition coding to the payload to produce robust message.

4. Optionally transform robust message according to a scrambling key.

5. Combine each symbol of the robust, and potentially scrambled message, with a carrier signal, such as by modulating pseudo random carrier signal with message symbols and map discrete signal elements to spatial image locations within a block (e.g., a fixed block size).

6. Replicate the blocks by arranging them in a contiguous array of a size that matches the host document page size.

The calibration signal attributes may form part of the carrier signal, may comprise a separate signal, or may be formed by arranging the embedded code signal in a repetitive pattern. Any of these approaches may be used to create a hidden pattern that enables the reader to detect the embedded code signal and compensate for geometric distortion, including rotation, scaling and the origin of each block.

Processes for generating this type of embedded code signal are described in assignee's U.S. patent application Ser. No. 09/503,881 and U.S. Pat. No. 6,122,403, which are incorporated by reference.

In addition to providing robust embedded auxiliary data, the embedded code signal may also include additional signals or signal components that are used for copy detection. Copy detection refers to a feature of the document that enables the automated reader software or hardware to discern whether it is an original printed version of the document, or has undergone a generation of copying, e.g., scanning and re-printing. For examples of using digital watermarks for copy detection, see U.S. Pat. No. 6,332,031, International Applications PCT/US01/23336 (published as WO 02/09019) and PCT/US02/20832 (published as WO 03/005291), and U.S. patent application Ser. No. 10/045,654 (published as U.S. 2002-0157005 A1), which are hereby incorporated by reference. The copy detect methods in PCT/US02/20832 are particularly suited for color documents. The out-of-phase approach discussed in PCT/US02/20832 can be used to create a substantially imperceptible background tint carrying a copy detect signal, particularly for CMYK printed documents. Most reproduction devices cannot fully reproduce the copy detect signal in copies. As such, the reader can be equipped with a copy detect signal reader in conjunction with IR illumination to detect whether a document is an original or copy.

Depending on the application, the payload may include message parts to carry: a source identifier, a unique document identifier, copy or usage control instructions, document classification codes, etc. The message parts of the payload may serve as indices to database entries stored within the reader or in a remote database. This enables the message parts to be represented by a compact index number that refers to a larger, and potentially variable, set of data.

The embedded code signal generated by this process may be embedded in a rasterized version of a document in a variety of ways as detailed further below. A rasterized document is one in which the various data in the electronic file representation of the document is converted into an image form. Specifically, the rasterized image comprises an array of elements called pixels or dots, where each element has a binary value of 1 or 0, called a binary image. Each value represents the presence or absence of ink at the corresponding location on the printed page. For color images, like CMYK images commonly used for color printing, there are actually four separate binary image channels or planes, each corresponding to a different ink color: Cyan, Magenta, Yellow and Black. The embedded code signal may be carried in luminance (e.g., variations in brightness), or some other color channel. In color images, luminance variations may be embedded by making variations to one or more of the color planes of the image to achieve the desired change in luminance.

The process of converting an electronic document to a rasterized image is sometimes referred to as the RIP process. This process is also referred to as halftoning or halftone conversion, particularly in the case of converting multi-value per pixel images or “bitmaps” to binary images for printing. For the purpose of describing our system, we will refer to the process of converting an electronic file to a binary image for printing as “rasterizing.”

The embedder may insert the embedded code signal into a document before, during or after rasterizing. For example, the embedded code signal may be inserted in the pre-rasterized version of the document, and combined into the rasterized document during the rasterizing process. Alternatively, the embedded code signal may be combined with rasterized document during or as an output stage of the rasterizing process.

One approach for inserting the embedded code signal is to modify the luminance of the rasterized image by either: 1. Expanding or increasing the boundaries of text characters to decrease or increase the luminance at locations in the rasterized image according to the embedded code signal values mapped to those locations; or 2. Selectively switching halftone dots to black or white to modify the luminance at locations within the rasterized image according to the embedded code signal values mapped to those locations. These approaches are similar in that they directly modify the rasterized image representation of the characters and other graphics or line art in the document. These approaches can be classified as methods for digitally watermarking halftone images. Examples are described in U.S. patent application Ser. No. 09/074,034 (now U.S. Pat. No. 6,449,377), Ser. Nos. 09/689,226, 09/840,016 (published as U.S. 2002-0054355 A1), and Ser. No. 10/052,895 (published as U.S. 2002-0105679 A1), which are hereby incorporated by reference.

Yet another approach for inserting the embedded code signal is to add it as a background tint. This approach shares similarities with the above approaches in that it modifies the luminance or other color channel in the printed image to convey hidden auxiliary information. However, rather than modify the image representation of characters, graphics, line art and other visible structures on the page, it appears in the background white space surrounding the visible structures on the page. In one particular implementation, the embedder generates a pseudo pattern or texture of embedded code signal blocks as described above that appears as a tint, and embeds this embedded code signal into a document by placing it in the background behind text, line art, and other visible structures etc. on the document. In our description, we will use the background tint as an example to illustrate the system.

The background tint approach shares similarities with digital watermarking in that the methods used to generate the embedded code signal for embedding are the same or similar as methods for generating a digital watermark signal for embedding into a picture, audio file or video stream. In this case, there is less of a concern for avoiding the introduction of visible artifacts in the printed document.

In either approach, the embedded code signal is replicated across an entire page or pages of the printed document so that the auxiliary data carried in it is completely extractable from excerpts of any page where it is embedded. In one particular implementation, the code signal is replicated in contiguous blocks, so a compatible embedded code signal reader can extract the auxiliary data from any excerpt that includes one of these blocks.

The embedder in this system is particularly designed to integrate with documents represented in Page Description Language (PDL) format, like Printer Control Language (PCL) from Hewlett Packard, Portable Document Format (PDF) or PostScript (including EPS) from Adobe. In this particular configuration, the user creates the documents using an application program. The system converts the files to PDL format and inserts the embedded code signal either before, during or after rasterizing the PDL representation to a binary bitmap image ready for printing.

The PDL representation enables flexibility in embedding the embedded code signal. For example, in the case of a background tint, the background tint may be inserted in the PDL representation before, during or after rasterizing the PDL file contents. The background tint may be represented as a multi-value per pixel image that is inserted in the PDL representation and rasterized along with the document, and inserted as a background tint. Alternatively, the background tint may be a binary image (e.g., pre-rasterized) such that the rasterizer superimposes the rasterized version of each page of the document on the background tint.

Embedding

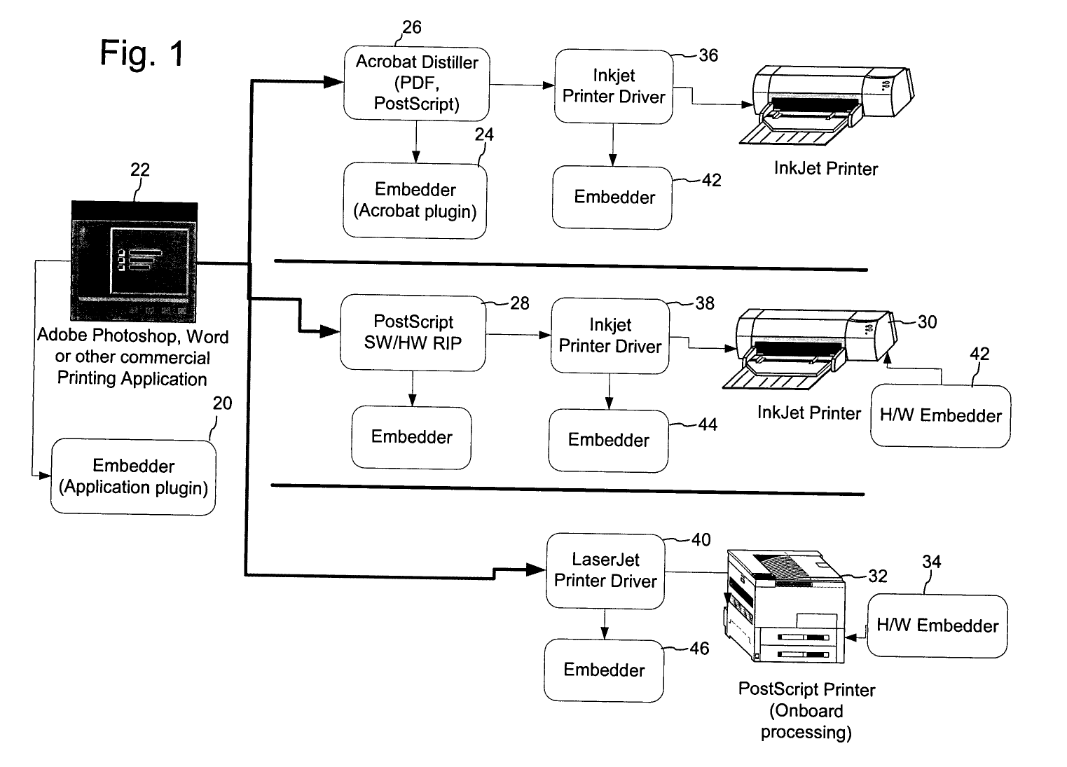

FIG. 1 is a system diagram illustrating locations of embedders for embedding auxiliary data in the embedded code signal in documents. This particular system is particularly adapted for documents that are in a PDL format or are converted to this type of format before printing. The embedder is preferably integrated into the document creation process in a closed environment for government or corporate organizations. The embedder inserts auxiliary data and control instructions during a file save or print operation (e.g., when the document is saved or printed to PDF or postscript format) such that the auxiliary data is locked to the document.

The embedder may be implemented in software, hardware, or a combination of both. In the case of software, the software executes on a computer connected to office equipment used to render the document or in software that executes within the office equipment as part of the document rendering process. The embedder software may be located in an application program or plug in for an application program, in a device driver, or an operating system.

In the case of hardware, the hardware may be implemented as an application specific integrated circuit and/or embedded system and firmware in office equipment, such as printers, scanners, and copiers.

The embedder operation can be invoked at the user's option or automatically. In the first case, the embedder is typically a software component executing on the user's computer, and this component provides a user interface that enables the user to control aspects of the embedding process. These aspects include, for example, being able to specify a portion of the embedded code's payload, such as an identifier, document classification, copy control instruction, copy control state, etc. Specific examples of message options include: 1. No additional copies allowed; 2. Copy allowed with banner indicating, “confidential material” etc. The document identifier can be used to track specific document transactions, such as file opening, saving, editing, printing and copying, by enabling the reader to store time, date, place, person, machine and other context information gathered at the time the document is opened, saved, edited, printed, and/or scanned. To accomplish tracking, the reader stores a transaction event along with the document identifier and this other context information in response to detecting the embedded code in a document.

Examples of software components that provide a user interface for the embedder include a printer driver program, a RIP program, and a plug in for an application that processes the document. In the case of a printer driver and RIP program, the user interface is a dialog box presented when the document is sent to the printer for printing. The plug in may be designed for document editing software, such as a word processor, or other document processing software such as a plug in for Adobe Acrobat.

For automatic embedding, the embedder may also be implemented in an application or plug in for an application, in a device driver, operating system, or office equipment hardware. Automatic embedding operations ensure that documents within the closed system are tagged with appropriate usage control, forensic tracking and/or linking information before being rendered or reproduced. For example, all documents from a particular person, entity, department or machine may be tagged with a particular classification, usage control instruction or rule, time/date tag, banner instruction or rule, persistent link to a database, and/or forensic tracking identifier.

As shown in FIG. 1, the embedder may be implemented as a plug-in 20 to an application program 22 used to create documents in the system. Some examples of application programs include image editing programs like the Adobe Photoshop program, word processing software like Microsoft Word or WordPerfect from Corel, and other desktop or commercial printing applications.

The embedder may also be implemented as a plug in 24 or integrated software for Adobe Acrobat. For example, embedder software may be programmed to intercept distiller data for PDF and PostScript files and insert the embedded code signal in these files. In this case, the embedder intercepts document files printed to the distiller 26 and inserts the embedded code signal. Alternatively, the embedder may be integrated into the Adobe distiller printer driver 26 for automatically or selectively inserting the embedded code signal to document files sent to the distiller.

In another alternative, the embedder is integrated into the software or hardware RIP 28 for PostScript files. As shown in FIG. 1, the RIP process 28 receives document files destined for printing on a printer 30. In some cases, the RIP process is executed in hardware on the printer, such as the case for PostScript printers 32. In this case, the embedder software/firmware code 34 is integrated into the RIP process, and is executed in the printer hardware.

In another alternative, the embedder is integrated into the printer driver. FIG. 1 shows three examples of printer driver configurations 36-40. In each case, the embedder 42-46 is integrated directly into the printer driver 36-40, and it inserts the embedded code signal into documents sent to print via the printer driver. As noted, this embedding operation may occur before, during or after the RIP process.

Finally, another alternative is to implement the embedder 34, 42 in the firmware or hardware of the printer 32,30. In this case, the embedder operation may be before, during or after the RIP process. Above, we discussed implementing the embedder 34 in the PostScript RIP process. In this case, the embedder 42 may be in a different RIP process or outside the RIP process, yet within the printer hardware.

In addition to the embedded code signal, which is inserted as a background tint and/or digital watermark in the rasterized image using halftone image watermarking, the embedder may also insert a banner image. This banner image is designed to be a visible marking that conveys information to the person handling the physical document output from the printer. Examples of banners include a marking that states: “Confidential”, “Classified”, “Printed by Captain Smith at 20:05, Dec. 1, 2001”. As shown in these examples, the information conveyed in the banner may be static or variable. In addition, the banner information may be inserted in the PDL file of a document, yet only printed selectively depending on the context at the time of printing. For example, the banner may be selectively printed based on a rule associated with the banner that specifies the events that trigger the printing of the banner. These events include the time and location of the printing, the machine of printing, the user or entity that prints the document, or some combination of these events.

Reading

Readers of the embedded code signal may be located in a variety of places within the system. Since the embedded code signal performs different functions, such as copy control, forensic tracking, and persistent linking to related data, the reader may be located at different places and equipped with different functionality to exploit one or more of these functions. As noted previously, the embedded code signal is inserted in an electronic form of the document and exists in that electronic form either before or after rasterizing the document. As such, readers may be deployed in locations with the system that process the electronic form of the document having an embedded code signal.

Further, the embedded code signal survives the transformation to the physical document as well as a digital scanning of the document. As such, readers may be inserted in the path of the image stream captured from the document with a scanner, copier machine or camera. Because of this capability to survive printing and scanning, the embedded code signal provides enhanced functionality beyond what can be achieved with document management systems that operate only on electronic documents, such as those that rely on encryption or a form of digital watermarking that does not survive printing and scanning.

In our implementation, the reading process is as follows:

1. Convert the digital image to luminance (if necessary) and filter to minimize interference of host document image on the embedded code signal.

2. Detect and identify the orientation and origin of embedded code signal tiles based on calibration signal component.

3. Extract signal estimates by demodulating embedded code signal elements from the image using the carrier signal.

4. Perform inverse scrambling using key.

5. Perform error correction and repetition decoding (e.g., inverse of the error correction used in the embedder, such as block codes, convolution codes, turbo codes, etc.).

6. Check fixed message part, and perform error detection to validate message.

Since the embedded code signal is tiled across the page, this entire read process can be performed on any portion of the page as small as a single tile. However, more robust detection can be gained by combining results from multiple tiles.

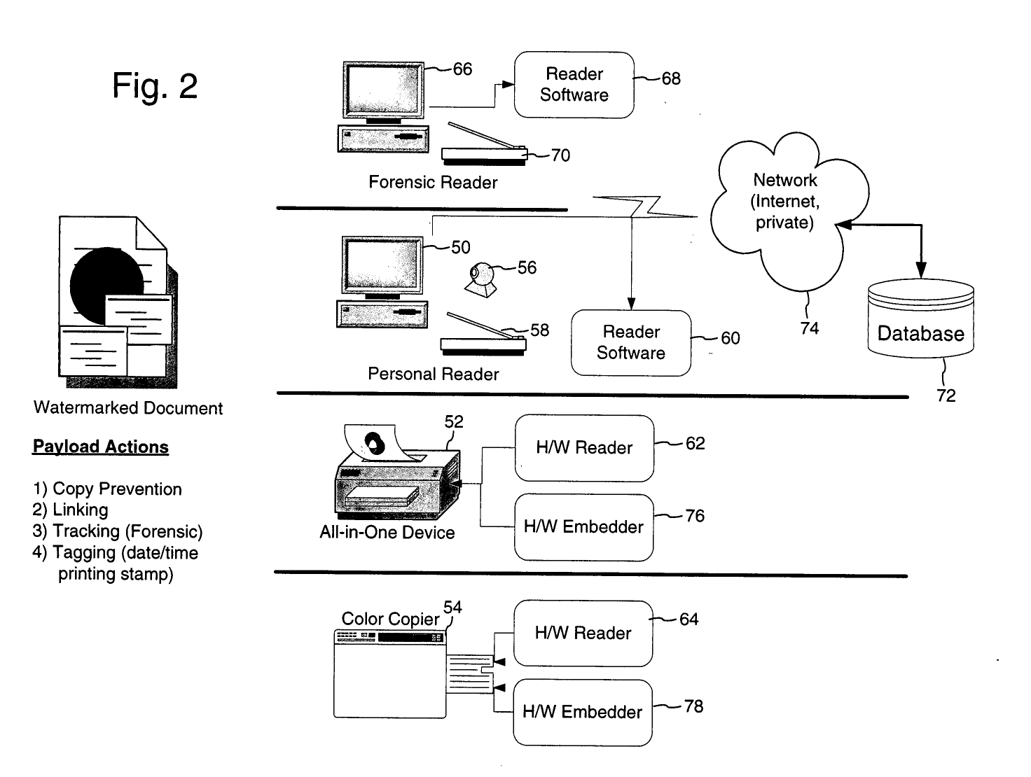

FIG. 2 is a system diagram illustrating the locations of readers for extracting the embedded data from printed documents. Using this diagram, we will discuss the location of the reader for the following functions:

1. Copy control, including inhibiting printing or reproduction or allowing printing or reproduction with a visible banner.

2. Persistent linking to related data and/or actions.

3. Tracking the document to its source.

4. Tagging the document (e.g., with a date/time stamp) with a hidden embedded code or visible banner.

In each of the above cases, the reader may additionally be programmed to store a transaction log of all detection events along with pertinent information extracted from the embedded code signal as well as related context information, such as the time, location identifier, user identifier, machine identifier of the detection event. This transaction log can then be uploaded from the reader to a searchable database management system that provides reports of detection event by document identifier, user identifier, time, machine etc.

Referring to FIG. 2, a reader with copy control functions may be implemented in a personal reader 50, an all-in-one device (e.g., printer, scanner, copier, fax machine) 52 or color copier 54. In “all-in-one device” is also referred to as a multi-functional device, and typically includes a digital scanner and printer as well as a network and/or telephone line connection for printing, copying, faxing, and scanning hard copy documents and sending electronic copies of hardcopy documents in email. In these examples, the document is in physical form, and an image capture device captures a digital image of the document. The reader then extracts the embedded signal from the digital image of the document. For copy control functions, the embedded signal includes data or an instruction that designates a particular copy control action. The data may include a classification code or index to a look up table that specifies the copy control action. The copy control action may be triggered by the embedded code signal and context information. For example, copy control rule may be defined that triggers a copy control action in response to a combination of the embedded code signal and particular context data, such as a user identifier, time and place, machine identifier, etc.

The image capture device may include a camera 56 or scanner 58 connected to the computer 50 in which the reader executes, a scanner in the all-in-one device 52, or a scanner in the copier 54.

In the personal reader system, the reader is implemented in software (e.g., software reader 60) that executes in the computer 50. In the all-in-one device 52 and color copier 54, the reader 62,64 is implemented in hardware or software that executes on a processor inside the device 52, and copier 54, respectively.

Another use of the embedded code signal is to link the physical document to electronic data and/or programmatic action. In this case, the reader software may be implemented in the personal reader 50 or forensic reader 66. The forensic reader is similar to the personal reader in that it includes a processor device (e.g., a computer or hand held device) with processor and memory for executing the reader 68. The forensic reader system also includes an image capture device, such as a scanner 70, to capture a digital image of a physical document.

The reader may be implemented in a mobile device (e.g., a wireless reader that communicates with other devices via a wireless connection), a tethered devices (a reader that is tethered to a computer or other processing device), or a reader station (such as a kiosk with a reader, computer and display).

For linking applications, the reader communicates with a local or remote database 72. In the example shown in FIG. 2, the reader software 60, 68 communicates with the database 72 through a computer network 74, such as the Internet, or a private network. The embedded code signal includes data, such as an index or other identifier, that is used to trigger an action, such as returning related data to the reader or invoking some programmatic action. The data may be used to look up a corresponding entry or action in the database, which in response, returns related data, initiates an action or both. For example, the database entry may store a pointer to an electronic version of the document and a program for editing that document. The database entry may store a pointer to an HTML page with information about the document, as well as hyperlinks to related information and programmatic actions. These hyperlinks include pointers or addresses of files on a wide area network, such as the Internet, a local area network, or a local computer storage device. The user can then view, edit or perform other actions relating to the document using the user interface of the reader software application executing on a computer or other processor-based device (e.g., hand held PC, personal digital assistant, cell phone, etc.).

Another use of the embedded code signal is for forensic tracking applications. The reader with forensic tracking functionality may be implemented in the personal or forensic reader systems described above. In forensic tracking applications, the embedded code includes a source identifier that identifies the user and/or machine that printed the document. The source identifier may act as an index to a database entry in the database 72 that provides additional information about the document and/or its source. Forensic readers may be automated and inserted in places where documents with embedded code signals flow through a network. In such a configuration, each reader automatically extracts the source identifier from embedded codes in documents that it intercepts and keeps a log of each detection event.

Another use of the embedded code signal is tagging a document with stamp that is either a visible banner or an embedded code signal whose existence is not readily apparent to viewers of the document. To implement this tagging function, a reader, such as the hardware readers 62, 64 in the all-in-one and copier devices, extracts the embedded code signal from a digital image of the document, and in response, inserts the tag in the electronic version of the document before it is printed. The response of the reader may be governed by a rule that specifies the conditions that need to be present to cause the tag to be embedded. For example, during a copy or print operation, the reader detects the embedded code signal, evaluates the rule, and if the conditions of the rule are satisfied, it triggers the embedding of another embedded code signal or the insertion of a visible banner. The resulting printed document then carries the new embedded code signal and/or visible banner. All-in-one devices 52 and copiers 54 may be equipped with hardware embedders for inserting the tag in an embedded code signal, such as a background tint or halftone watermark signal. These embedders may embed a static code signal, or one with variable data, such as information about the user, the time and date of reproduction, etc.

The discussion above specifically discussed applications of the reader on digital images scanned from physical documents. However, since the embedded code exists in both electronic and physical documents, the reader may also operate on electronic documents with embedded code signals. This enables the reader to monitor email traffic for embedded code signals as well as documents that are stored in persistent storage (a document server, printer server, user's hard drive, etc.). For example, the reader may be implemented as part of network spider program that crawls through file server directories, and keeps a log of documents and their locations based on the embedded code signals. For example, one implementation of a spider program fetches documents stored on a network, extracts the embedded code signal, if any, and keeps a log of the detection event, including information from the embedded code signal and information about the time and place the file was created and saved, and by whom. To avoid duplicative processing, the spider tags electronic files indicating which ones it has previously logged to avoid duplicative processing of the files. More information on spidering functions and making the data captured by the spider program searchable is provided in PCT/US01/04812 (published as WO 01/61508).

In some configurations, documents sent for printing may be routed through a server or other print pre-process that includes an embedded code reader for implementing the various functions described above. For example, the reader may be implemented in a printer server for all networked multi-functional devices or digital scanners or digital copiers. Alternatively, the reader may be located at the digital copier/scanner/fax in software, firmware or hardware.

In addition to conveying the various payload messages described above, the embedded code signal may also carry a hash of content on the document, such as text on the document, so that the authenticity of the document can be verified by comparing the hash in the embedded code signal with a hash of the content on the document. At the reader, the hash may be computed by performing OCR on the text, and then performing a hash function on the text.

The embedded code signal may also be used to detect alteration of a document by determining where tiles of the embedded code signal, which have been spread contiguously over the page, are unreadable.

Another form of authentication is to check the embedded code signal for a document classification or departmental code to determine whether it is from a valid source, such as particular user or department. This function of the embedded code signal may be used in conjunction with the source identifier to pinpoint the source, and time and date of printing.

Once an embedder has inserted the embedded code signal in a document file, other devices and software that operate on the document can be controlled via the embedded code signal. Thus, for example, in the case of a PDL file that has the embedded code signal, file opening and editing operations may be controlled by readers implemented in application programs used to view and edit the document. The usage rights associated with the embedded code signal may not only control scanning, copying and printing, but also editing and viewing operations on the document file. These usage rights may be conveyed within the embedded code signal itself, or may indexed by the embedded code signal into a database of usage control rights.

This system may deployed in a similar manner in many different organizations, but in each case, the embedded code signal may employ a different key or embedded code signal protocol that is unique to that organization. One approach is to use a unique calibration signal for each organization. Another approach is to use a unique scrambling key. In particular, after forming the message and performing error correction coding, the resulting message can be scrambled with a unique scrambling key assigned to the organization.

As noted previously, different components on the embedded code signal may perform different functions. For example, detection of the calibration signal may trigger copy control functions, such as inhibiting printing or scanning of a document. The embedded code signal may include a message payload with a forensic tracking identifier used to track the source of the document, and a unique content identifier used for linking applications.

The methods described above apply to a variety of types of documents, including secure documents, value and financial documents (e.g., bank notes, checks, tickets), identity documents (e.g., passports, visas, driver's licenses, corporate badges, access badges, bank cards, ATM cards, smart cards), etc. In the case of identity documents, the system for logging detection events can be used in reader/verification systems used in access control, Point of Sale transactions, age verification, etc. In these applications, the detection events correspond to the reading of the digital watermark(s) and possibly other machine readable security features from a scan of the document. The recording of these events in the system database establishes a record of the time-date, place/location, identity of document bearer, document identifier and document image, and/or result of the verification process (e.g., a report of any anomalies detected in the document). As described above, this log may be associated with other context information associated with the detection event, such as the identifier of the reader, the operator, the venue, and any surveillance video captured at or around the time of the event. This system can also be applied at Point of Sale, back office database, and other verification locations for financial documents, such as banknotes, checks, debit and credit cards. In this context, back office refers to verification performed, at least in part, at a remote site, such as a central database or verification server that is communicated via network to reader terminals.

Concluding Remarks

Having described and illustrated the principles of the technology with reference to specific implementations, it will be recognized that the technology can be implemented in many other, different, forms.

To provide a comprehensive disclosure without unduly lengthening the specification, applicants incorporate by reference the patent documents referenced above.

The methods, processes, and systems described above may be implemented in hardware, software or a combination of hardware and software. For example, the auxiliary data encoding processes may be implemented in a programmable computer or a special purpose digital circuit. Similarly, auxiliary data decoding may be implemented in software, firmware, hardware, or combinations of software, firmware and hardware. The methods and processes described above may be implemented in programs executed from a system's memory (a computer readable medium, such as an electronic, optical or magnetic storage device).

The particular combinations of elements and features in the above-detailed embodiments are exemplary only; the interchanging and substitution of these teachings with other teachings in this and the incorporated-by-reference patents/applications are also contemplated.

1. A method of managing documents comprising:
receiving an electronic document that has not been rasterized, the electronic document including semantic information that is interpretable by a human when rendered to an output form for display or printing; and
embedding a machine-readable code signal into the document such that the code signal survives printing of the electronic document, wherein the code signal carries hidden auxiliary data that is not interpretable by a human viewer and does not change semantic meaning of the semantic information, the machine readable code signal being generated by modulating the auxiliary data with a carrier signal.

2. The method of claim 1 wherein the electronic document comprises a document in a page description language format including editable text.

3. The method of claim 2 wherein the code signal is inserted before rasterizing the editable text such that the editable text remains editable by a user after the code signal is inserted.

4. The method of claim 3 wherein the code signal is combined with a rasterized version of the text during a process of rasterizing the document for printing.

5. The method of claim 1 wherein the code signal comprises a background tint that is replicated across an entire page of the document such that the auxiliary data can be completely extracted from a plurality of different parts of the document.

6. The method of claim 5 wherein the code signal comprises a signal that is out of phase with a color component of a printed original, and that causes a detectable change in a color component after scanning or re-printing the original, the change enabling an automated reader to distinguish a printed original from a printed copy.

7. The method of claim 1 wherein the code signal comprises a halftone watermark wherein an image representation of the semantic information is modified to encode the auxiliary data by modifying halftone representations of the semantic information.

8. A computer readable medium on which is stored instructions for executing the method of claim 1.

9-23. (canceled)

24. The method of claim 1 wherein the hidden auxiliary data is readable from an image scanned from a printed version of the document, and the hidden auxiliary data includes information is used to control printing of a visible banner on a copy made of the document.

25. The method of claim 24 wherein the visible banner includes information about a user that causes the copy to be made.

26. The method of claim 1 wherein the hidden auxiliary data includes a source identifier that identifies a source of the document.

27. The method of claim 1 wherein the hidden auxiliary data includes data for determining whether a document in which the data is embedded is in an unauthorized location on a computer network.

28. The method of claim 1 wherein the hidden auxiliary data includes data for determining whether a document has been processed by an unauthorized user.
